(19) United States
(12) Patent Application Publication
(10) Pub. No.: US 2020/0118109 A1
(43) Pub. Date: Apr. 16, 2020

(54) Proximity Electronic Credit Exchange System And Method Therefor

(71) Applicants: Thierry Charles Hubert, Dallas, TX (US); Ross Power, Hillsboro, NH (US)

(72) Inventors: Thierry Charles Hubert, Dallas, TX (US); Ross Power, Hillsboro, NH (US)

(21) Appl. No.: 16/653,953

(22) Filed: Oct. 15, 2019

Related U.S. Application Data
(60) Provisional application No. 62/746,030, filed on Oct. 16, 2018.

(51) Int. Cl. G06Q 20/32; G06Q 20/20

(52) U.S. Cl. CPC G06Q 20/327; G06Q 20/209; G06Q 20/208; G06Q 20/204

(57) ABSTRACT

A proximity electronic credit exchange system and method therefor are disclosed. In the system, user devices (i.e. computing devices carried by individuals) in close proximity can transfer virtual cash in a direct, anonymous fashion using secured point-to-point wireless links established between pairs of the devices. The virtual cash is in the form of numerical credits. These devices are known as proximity credit transfer devices because they can transfer the credits without a connection to a communications network (e.g. internet, private network) and do not require a payment system to authorize or complete the transactions. A web services API defines an agreed-upon value for the credits in one or more currencies. Using network connected user devices (e.g. smartphones), the individuals can purchase credits at a payment gateway of a payment system via the web services API, propagate the purchased credits to the devices, and redeem the credits stored on the devices.

### RELATED APPLICATIONS

This application claims the benefit under 35 USC 119(e) of U.S. Provisional Application No. 62/746,030 filed on Oct. 16, 2018, which is incorporated herein by reference in its entirety.

### BACKGROUND OF THE INVENTION

A computing device includes at least one or more microprocessing units (MPU) and a memory. The MPU is a device that implements the core elements of a computer system on a single integrated circuit, or as a few integrated circuits operating as a cohesive unit, designed for the processing of digital data.

The MPUs have internal logic circuits that perform arithmetical operations and execute machine code instructions of applications (“application code”) loaded into the memory. The instructions control and communicate with input and output devices (I/O) such as displays, printers and network interfaces. Examples of computing devices include servers, network appliances, and user devices.

The MPUs of the computing devices are typically configured as either microprocessors or microcontrollers. A microprocessor often includes only the MPU in a physical fabricated package, or “chip.” As a result, computer designers must connect the MPUs to external memory and I/O to make the microprocessors operational. Microcontrollers, in contrast, typically integrate the memory and the I/O within the same chip that houses the MPU.

The microcontrollers and microprocessors execute the application code of the applications to extend the capabilities of the computing devices. In the microcontrollers, the application code of a single, monolithic application is typically pre-loaded into the memory before startup and cannot be changed or replaced during run-time. After startup, the microcontrollers pass control directly to the application for the duration of run-time. In contrast, the microprocessors are typically configured to work with an intermediate software layer known as an operating system that enables the application code of different applications to execute at different times during run-time. The operating system is configured to reside between the applications and the MPUs.

The operating system has different functions. The operating system enables application code of different applications to be loaded and executed at run-time. Specifically, the operating system can load the application code of different applications within the memory for execution by the MPU, and schedule the execution of the application code by the MPU. In addition, the operating system provides a set of programming interfaces of the MPU to the applications, known as application programming interfaces (APIs). The APIs allow the applications to access features of the MPU while also protecting the MPU. For this reason, the operating system is said to execute “on top of” the MPU, while the applications are said to execute “on top of” the operating system.

The user devices are portable computing devices that can be carried by individuals on their person. One group of the user devices, also known as network connected user devices, include one or more wireless communications interfaces that enable the devices to connect to various public or private communications networks. The public networks include the internet, while the private networks include satellite networks, cellular networks, or leased network provided by a service provider, in examples. These network connected user devices include cellular/mobile “smartphones,” tablets/phablets, and laptops, in examples.

The network connected user devices typically include an operating system and various applications that execute on top of the operating system. Example operating systems include Android, Linux, and Apple IOS, which are trademarks respectively owned by Google, Inc., The Linux Foundation, and Apple, Inc.

Common payment methods in modern society include cash, check, and credit card transactions. Cash transactions are transactions where payment for goods or services is in the form of physical currency (“cash,”) namely bank notes and coins, that are transferred at the point of sale between the parties. In cash transactions, the payment is settled immediately between the parties. Check transactions, on the other hand, come with the clear disadvantage that the receiver does not know if the funds are available before the check is cleared, are presented for payment at a bank, and are settled at a later date than the point of sale date. Payments using credit card transactions, in contrast, require a payment system for processing the credit transactions, and various payment equipment such as credit card readers installed at the point of sale. The payment equipment are in communication with the payment systems and accept credit cards as payment. While the payment systems provide a guarantee of the payment for the credit transactions, the credit transactions are also settled at a later date than the point of sale date.

Traditionally, individuals working in service industries such as lodging, food, entertainment, and transportation have relied on gratuities as a significant source of income. These individuals, also known as service personnel, generally expect to receive the gratuities, or “tips,” in consideration for the services provided. The amount of the tips are discretionary, where the served individuals often provide higher tips for exemplary service. Examples of service personnel include baggage handlers at airports, concierges and luggage handlers at hotels, tour guides, transportation “common carriers” such as cab drivers and train and bus personnel, and possibly even food servers and bartenders at food and drink establishments.

The service personnel most often interact with the individuals they serve, also known as served individuals, via brief, anonymous person to person/face to face service encounters. The encounters are usually brief and anonymous because the services are often completed in less than an hour or possibly even in a few minutes, and the service personnel must cater to possibly dozens of served individuals for each work day. The encounters are face to face because of the typically personal “one to one” nature of the services rendered.

The served individuals almost always provide the tips to the service personnel in the form of cash. This is because cash is universally accepted, the payment is settled immediately, and the amount of payment is discretionary. These aspects of cash-based, face to face transactions are critical for services of an anonymous and momentary nature.

In contrast, payment of tips for these service encounters using check and credit transactions have many disadvantages. Both check and credit transactions are settled at a later date than the point of sale date. In addition, these transactions are highly impractical. For example, because of the anonymous and brief nature of the encounters, the check transactions create a heightened uncertainty of payment for the service personnel, and also require the service personnel to present the checks for payment at a bank. In another example, the credit card transactions require the service personnel to have working payment equipment (possibly on their person), and the served individuals to be carrying a valid credit card. These credit card transactions are feasible for some service personnel such as cab drivers, who have payment equipment installed in their cabs/vehicles. However, the credit card transactions are not feasible for most other service encounters, because the encounters are face-to-face and the service personnel lack immediate access to the payment equipment.

Cash is also a preferred payment method at various venues of short duration and some retail business establishments. Examples of the short-term venues include county and state fairs, amusement/theme parks, outdoor sporting events, and traveling shows such as circuses and carnivals. The small retail businesses that prefer cash are usually independent, family owned businesses such as coffee shops and restaurants. These venues and businesses typically prefer or exclusively accept cash to avoid the same pitfalls associated with payment via the check and credit transactions listed herein above.

At the same time, the payment methods are increasingly becoming electronic in nature. One electronic payment method allows service personnel carrying user devices to accept credit card payments from the served individuals. In this method, the user devices include the payment equipment (e.g. a credit card reader and the wireless transceivers that enable access to the communications networks, such as the internet) and the applications communicate over the internet to a payment system. The payee physically swipes the payor's credit card at the credit card reader of the user device, and enters the payment amount at the application. The application then sends the credit card information and amount wirelessly over the internet to the payment system, which authorizes and completes the credit transaction.

Another electronic payment method allows served individuals carrying user devices to make credit transactions at terminals of point of sale systems, using the applications on the user devices. Here, the application on each user device includes credit card information of the served individuals, and communicates wirelessly with a wireless reader terminal at the point of sale system. The terminal, in turn, communicates over the internet with the payment system. In more detail, the served individuals present their user devices in physical proximity to the wireless reader terminal, and the application typically creates a short distance wireless link (e.g. near field communication, or NFC link) to the wireless reader. The application sends the credit card information and payment amount over the short distance link. The wireless reader at the point of sale system then communicates the credit card information and amount wirelessly over the internet to the payment system, which authorizes and completes the credit transaction. Examples of these payment systems include Samsung Pay and Apple Pay

These electronic payment methods are often feasible and beneficial in retail business settings and urban areas that have the infrastructure required to support the payment methods. This infrastructure includes electricity, payment equipment/terminals, and cellular and/or wireless access to the internet, and communication with the payment systems. The payment systems carry out the electronic payment methods and log the transactions.

### SUMMARY OF THE INVENTION

Because of the increased availability of the electronic payment methods, individuals are increasingly forgoing paying for goods or services in cash, or even carrying cash on their person. In the United States, for example, it is estimated that at least ten percent of individuals do not carry cash at all. In another example, cash transactions in Norway currently account for less than three percent of all financial transactions. Kai A. Olsen (2018), A Cash-free Society, Whether We Like It or Not, Lanham, Md.: Rowman & Littlefield Publishing Group, Inc.

The decreased use of cash and the decrease in the number of individuals that carry cash is causing problems during the service encounters, at the short-term venues, and at the businesses that only accept cash. The service personnel are increasingly being put in the uncomfortable position of either telling potential clients that they only accept cash before performing services, or else risk the possibility of not being paid (i.e. not receiving tips) in consideration for their services. Moreover, when the served individuals are traveling on business or on vacation, they are often are not carrying cash on their person, and also could be travelling in countries or areas where even credit cards and the electronic payment methods are not accepted forms of payment. As to the short-term venues and the businesses that only accept cash, they might either lose business when potential customers cannot pay in cash, or must install and maintain automated teller machines (ATMs) that the customers can access to provide cash payments. The ATMs require access to the internet or other network that communicates with a payment system, and require maintenance and periodic replenishing of cash, which adds cost.

While the existing electronic payment methods are often feasible and beneficial in many retail business settings and in urban areas, these payment methods are often neither feasible nor practical for many if not most of the service encounters and the short-term venues. There are simply too many variables that preclude use of these payment methods for the momentary duration and anonymous, face-to-face nature of the service encounters. In one example, the user devices would need to be running the latest required financial applications, and the applications on the user devices would have to be compatible with one another across different user device platforms (e.g. Android, Apple OS). In another example, the user device application of the served individuals would either need to be pre-configured with credit card information, or the user device of the service personnel must have a working credit card reader. In yet another example, the payment methods require that the user devices communicate with a payment system to authorize and complete the underlying credit transactions of each payment method. For this purpose, the user devices must have uninterrupted wireless internet access (e.g. WiFi, cellular connection) for communicating with the payment systems.

An inventive credit management system is proposed. This system includes pairs of user devices in close proximity to one another that can execute anonymous, person-to-person electronic payments, in the form of virtual cash (“credits”). In each pair, a sender device sends a selected amount of stored credits directly to a paired receiver device. The sender device is carried by a payor such as a served individual, and the paired receiver device is carried by a payor such as service personnel. Unlike the existing electronic payment methods, the user devices in each pair can transfer credits to each other without requiring a connection to a communications network (e.g. internet, cellular network, or private network) and do not require communications with a payment system to authorize or complete the transactions. These user devices are also known as proximity credit transfer devices.

The proximity credit transfer devices are configured either as sender devices or receiver devices, and a sender device can securely transfer at least some of its stored credits directly to a specific receiver device. To ensure that the sender device transfers its credits to the specific receiver device and not to other receiver devices that might also be located within close proximity to the sender device, the sender device first executes a pairing process. Via the pairing process, the sender device determines a receiver device that is both within an allowed proximity distance and is in closest proximity to the sender device. Such a receiver device is also known as the paired receiver device. The sender device then establishes an encrypted wireless point-to-point link with the paired receiver device, and transfers the selected amount of its stored credits over the link to the paired receiver device.

In general, according to one aspect, the invention features a credit management system. The system comprises proximity credit transfer devices that each have a body and that each include device data and credits stored within the device data, and a user interface. The user interface configures the proximity credit transfer devices as sender devices or receiver devices and selects at least some of the stored credits (“selected credit amount”) at the sender devices.

In response to a physical impact detected at the body of a sender device, the sender device pairs a receiver device that is in closest proximity to the sender device, and creates an encrypted point-to-point wireless link with the paired receiver device and sends the selected credit amount over the link to the paired receiver device.

Preferably, each of the proximity credit transfer devices include a central processing unit (MPU), one or more impact sensing devices that detect physical impacts at the bodies of the proximity credit transfer devices and send signals indicating the impacts to the MPU, and a wireless transceiver that the MPU enables upon receiving the signals indicating the impacts.

In one embodiment, the sender device is a network connected user device that has been adapted to operate as a network connected proximity credit transfer device. Additionally or alternatively, the paired receiver device is a network connected user device that has been adapted to operate as a proximity credit transfer device.

Typically, each of the receiver devices listen for a wireless pairing request message sent from the sender device in response to a physical impact detected at the body of each receiver device, and then send a wireless pairing response message to the sender device.

The sender device pairs the receiver device in closest proximity to the sender device by selecting the wireless pairing response message with the highest received signal strength indicator (RSSI) value, and using a proximity device identifier (ID) of the selected wireless pairing response message to identify the paired receiver device.

Preferably, a physical impact detected at the body of a specific receiver device and the physical impact detected at the body of the sender device are the result of the body of the sender device physically impacting the body of the specific receiver device.

In one example, after the sender device detects the physical impact upon the body of the sender device, the receiver devices must be located within a proximity distance of one meter or less from the sender device and remain so for an event window time period maintained at the sender device in order for the sending of the selected amount of credits to be successful.

Preferably, the sender device sends the selected credit amount over the link to the paired receiver device with a security code, and the paired receiver device accepts the selected credit amount upon determining that a security code of the receiver device matches the sent security code.

Additionally, in response to the sending of the selected credit amount, the paired receiver device increases its credits by the selected credit amount and stores the credits to its device data, and sends a transaction receipt message to the sender device; and in response to receiving the transaction receipt message, the sender device decreases its stored credits by the selected credit amount and stores the credits to its device data.

The system further comprises a web service API, applications executing on network connected user devices that are each associated with a specific user, are in communication with the web service API, and are each registered with a particular proximity credit transfer device. The applications for each of the users enable the users to purchase credits at the web service API, and propagate the purchased credits to the registered proximity credit transfer devices; and extract at least some of the stored credits from the registered proximity credit transfer devices, and redeem the at least some of the extracted stored credits at the web service API.

In general, according to another aspect, the invention features a credit transfer method. The method comprises configuring a proximity credit transfer device as a sender device and other proximity credit transfer devices as receiver devices; and the sender device detecting a physical impact at a body of the sender device. In response to the sender device detecting the impact, the sender device accesses credits stored in device data of the sender device and selects an amount of the stored credits (“selected credit amount”); pairs a receiver device in closest proximity to the sender device; and creates an encrypted point-to-point link with the paired receiver device and sends the selected credit amount over the link to the paired receiver device.

The method further comprises the sender device receiving a transaction receipt message from the paired receiver device over the link, in response to the paired receiver device accepting the selected credit amount sent by the sender device; and reducing its stored credits by the selected credit amount.

Additionally, the method comprises registering applications executing on network connected user devices to communicate with the proximity credit transfer devices, and enabling users associated with each of the applications to purchase credits via a web service API; each of the applications propagating the purchased credits to the registered proximity credit transfer devices; and the applications extracting at least some of the stored credits from the registered proximity credit transfer devices, and redeeming the at least some of the extracted stored credits at the web service API.

The above and other features of the invention including various novel details of construction and combinations of parts, and other advantages, will now be more particularly described with reference to the accompanying drawings and pointed out in the claims. It will The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic diagram of a proposed credit management system that is in communication with a payment system, where the credit management system includes low-power proximity credit transfer devices, according to one embodiment;

FIG. 2A is a schematic diagram showing detail for an implementation of an exemplary low power proximity credit transfer device of the credit management system in FIG. 1;

FIG. 2B is an image of a working prototype of a low power proximity credit transfer device in FIG. 2A, where a top portion or cover of a body of the device is shown removed from a base portion of the body, and where various components of the device are visible;

FIG. 3A is a block diagram showing various data members of an exemplary user account stored for an individual that is a registered user of the credit management system;

FIG. 3B is a block diagram showing various data members of an exemplary instance of device data stored within a proximity credit transfer device;

FIGS. 4A and 4B are respectively top and perspective views of a low power proximity credit transfer device, as in FIG. 1;

FIGS. 5A and 5B are sequence diagrams that show a credit transfer method for the credit management system in FIG. 1;

FIG. 6 is a sequence diagram that shows a propagation method of the credit management system in FIG. 1, for purchasing credits and propagating the purchased credits to the proximity credit transfer devices;

FIG. 7 is a sequence diagram that shows a redemption method of the credit management system in FIG. 1, for redeeming at least some of the credits stored on the proximity credit transfer devices;

FIG. 8A-8H are images of display screens of low power proximity credit transfer devices, which the devices render on displays of the devices during various modes of operation of the devices;

FIG. 9 is a schematic diagram of another proposed credit management system that is in communication with a payment system, where the credit management system includes at least one network connected user device (e.g. smartphone) that has been adapted to operate as a proximity credit transfer device, according to another embodiment;

FIG. 10 is a block diagram showing more detail for the smartphone network connected user device in FIG. 9, which has been adapted to operate as a proximity credit transfer device; and

FIGS. 11A and 11B are sequence diagrams that show a credit transfer method for the credit management system in FIG. 9.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

It will be understood that although terms such as “first” and “second” are used herein to describe various elements, these elements should not be limited by these terms. These terms are only used to distinguish one element from another element. Thus, an element discussed below could be termed a second element, and similarly, a second element may be termed a first element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

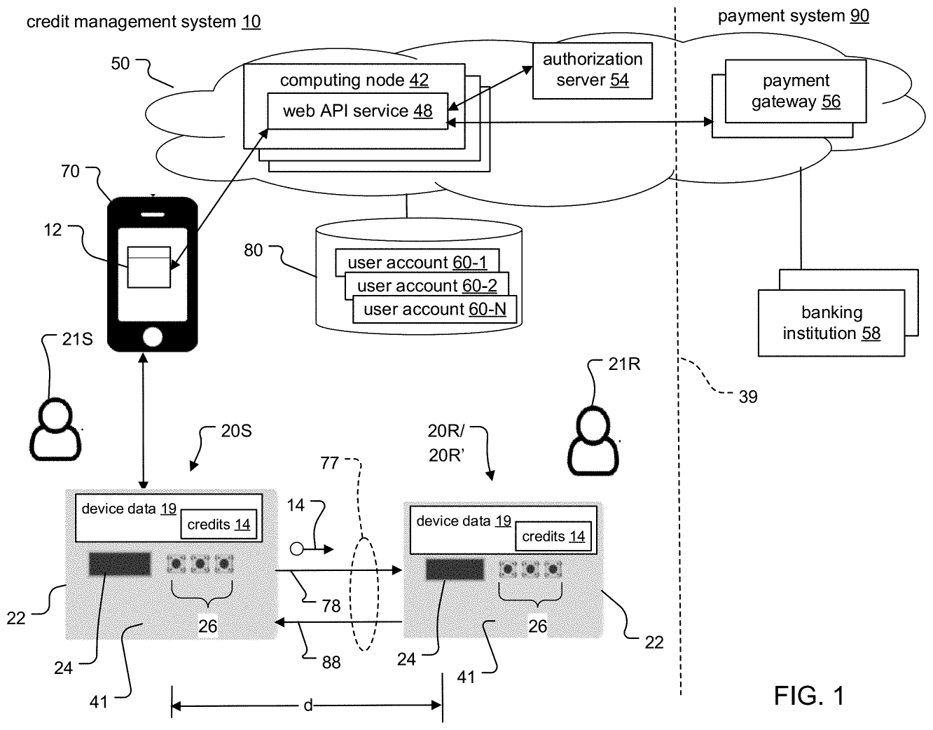

FIG. 1 shows an exemplary credit management system 10 that is in communication with a payment system 90. A separation boundary 39 is shown that helps the viewer separate components of the credit management system 10 from those of the payment system 90.

A network cloud 50 is also shown. The network cloud 50 is a public or private communications network that is remote to the proximity credit transfer devices 20. In one example, as shown, the network cloud 50 is the internet. In another example, the network cloud is a 50 private or leased network.

The credit management system 10 has various components. These components include proximity credit transfer devices 20, an authorization server 54, one or more computing nodes 42, a web API service 48 and a user account database 80. Two proximity credit transfer devices 20S and 20R that are respectfully carried by individuals 21S and 21R are shown in the figure. The credit management system 10 also includes network connected user devices 70 (here, a smartphone) carried by and associated with each of the individuals 21 and their proximity credit transfer devices 20. Only one network connected user device 70 associated with individual 21S and device 20S is shown.

The payment system 90 includes one or more payment gateways 56 that are in communication with one or more banking institutions 58. Payment gateways are internet-accessible services that enable individuals to send and accept electronic payments, via credit cards of the individuals that are registered with the service. One example of a payment gateway is PayPal, Inc. The banking institutions 58 maintain financial accounts for the users 21 such as savings, checking, and credit card accounts.

Some of the components of the payment system 90 and the credit management system 10 access the network cloud 50, while other components of these systems 10, 90 are located within the network cloud 50. In more detail, the payment gateways 56 of the payment system 10 are included in the network cloud 50. Computing devices within the banking institutions 58 then access the payment gateways 56 via the internet/network cloud 50 or private communications link. In the credit management system 10, in one implementation (also as shown in the figure), the user database 80 connects to the network cloud 50, and the network cloud 50 includes the authorization server 54, the computing nodes 42 and the web API service 48.

The computing nodes 42 are typically general-purpose computing devices. Service providers can combine or arrange the computing nodes 42 to provide services to clients via the internet or private network connection. These services include storage, processing, and software services/software as a service (SaaS), in examples.

The web API service 48, in one implementation, is a combination of software and/or hardware components that execute upon at least one of the computing nodes 42 or across multiple computing nodes 42. The web API service 48 is in communication with the network connected user device(s) 70, the authorization server 54 and the one or more payment gateways 56. In the figure, the web API service 48 executes on at least one of the computing nodes 42 or across multiple computing nodes 42. In another implementation, the web API service 48 is included within and executes upon the authorization server 54.

The proximity credit transfer devices 20 each have a body 22 and include a display 24, a user interface 26 and device data 19. The user interface 26 allows the individuals 21 to configure and activate/operate the devices 20. Each of the devices 20 store at least credits to the device data 19.

In one embodiment, as shown in the figure, the devices 20S, 20R are low power proximity credit transfer devices. These low power proximity credit transfer devices are optimized to conserve power, and have a form factor that is typically smaller than that of the network connected user devices 70. A top portion or cover 41 of the body 22 of each of the low power proximity credit transfer devices 20 is visible in the figure. The displays 24 of the devices 20 seat within an opening in the cover 41 of the devices 20.

Each of the network connected user devices 70 include an application 12 that executes upon a MPUs of the user devices 70 and that communicates with other components. As shown in the figure, the application 12 of the smartphone network connected user device 70 carried by individual 21S communicates with the proximity credit transfer device 20S and various components in the network cloud 50, such as the web API service 48 and possibly the authorization server 54. The network connected user device 70 communicates with the proximity credit transfer device 20S using a short-distance wireless protocol such as traditional Bluetooth, Bluetooth Low Energy (BLE), ZigBee or Z-Wave, or proprietary wireless protocol. Preferably, BLE is used.

Compared to traditional Bluetooth, BLE is intended to provide considerably reduced power consumption and cost while maintaining a similar communication range. Operating systems including Apple iOS, Android, Windows Phone and BlackBerry, as well as mac OS, Linux, Windows 8 and Windows 10 all natively support Bluetooth Low Energy. The Bluetooth Special Interest Group (SIG) predicts that by the end of 2019, more than 90 percent of Bluetooth-enabled smartphones will support BLE.

The network connected user device 70 communicates with the network cloud 50 via various wireless protocols such as WiFi, or possibly using cellular communications (if supported by the user device 70).

The user database 80 includes user accounts 60-1 . . . 60-N of various individuals 21. Each user account 60 at least includes information that identifies an individual 21, and information for a specific user device 70 and a specific proximity credit transfer device 20 that are associated with that individual 21. The user database 80 is accessible via the network cloud 50. Alternatively, the user database 80 is implemented as a storage service across one or or more of the computing nodes 42 in the network cloud 50.

The credit management system 10 generally operates as follows.

An administrator of the system 10 uses the authorization server 54 to enter various information for registering the individuals 21 as users of the system. This information includes a user ID for identifying the individuals 21, and the associated network connected user device 70 and proximity credit transfer device 20 for that individual 21. The authorization server 54 stores this information to a user account 60 for each user/individual 21 at the user database 80.

The administrator registers the individuals 21 as users of the system 10 for the following reasons. First, the registration ensures that only authorized proximity credit transfer devices 20 can exchange credits with one another. Second, the registration allows the proximity credit transfer devices 20 and the network connected user devices 70 to receive system updates. In one example, the administrator can send updates to the applications 12 on the user devices 70. In another example, the administrator can send software/firmware updates to the proximity credit transfer devices 20 via the network connected user devices 70. Third, the registration allows the individuals 21 to purchase credits 14 for propagation to the proximity credit transfer devices 20, and for redemption of the stored credits 14 at the proximity credit transfer devices 20.

The administrator also defines various information for operation of the system 10 at the web API service 48. In one example, the administrator defines an agreed-upon value for the credits that the proximity credit transfer devices 20 transfer to one another. The agreed-upon value for the credits is then used by the web API service 48 during the propagation and redemption of the credits. In another example, the administrator configures a specific payment gateway 56 for the web API service 48 to access.

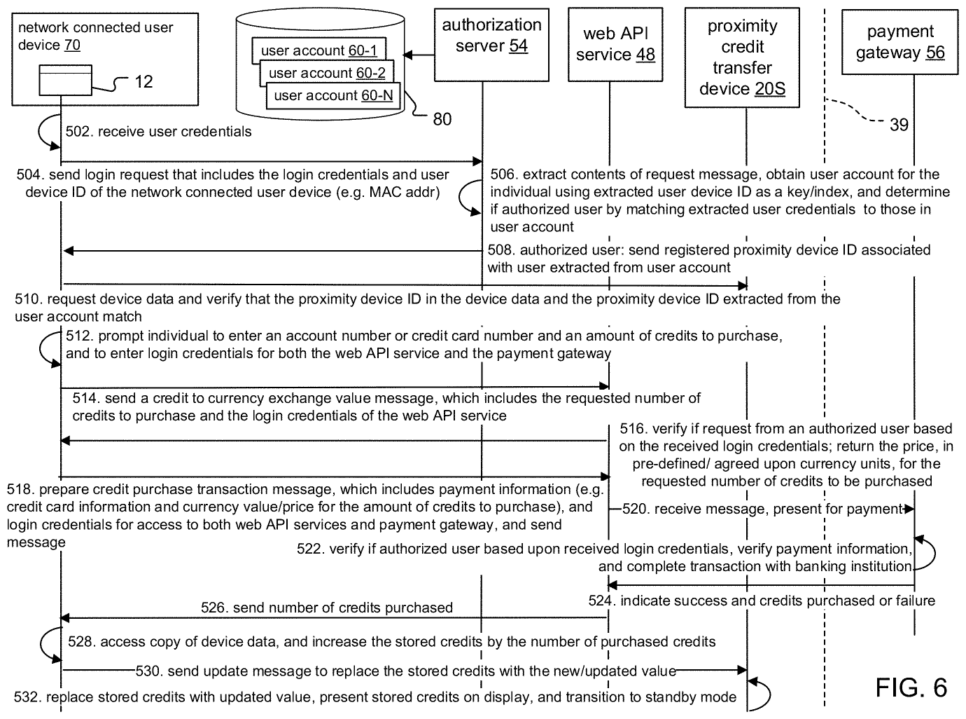

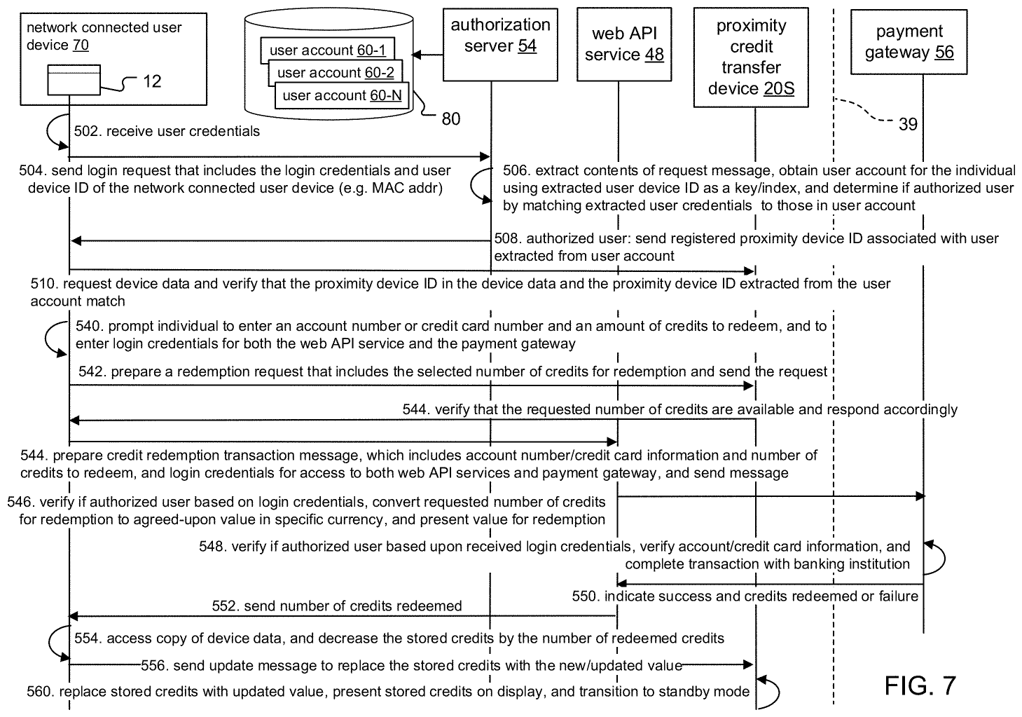

Both the propagation and the redemption methods have a communications path that includes the network connected user device 70 and the proximity credit transfer device 20 associated with each individual 21, the web API service 48, and at least one payment gateway 56 of the payment system 90. More details regarding the propagation and the redemption methods for the low power proximity credit transfer devices 20S,20R in FIG. 1 are respectively provided in the description associated with FIG. 6 and FIG. 7, included herein below.

Once the proximity user devices 20 are each registered to/associated with a particular individual 21 and network connected user device 70, the proximity credit transfer devices 20 must be configured as sender devices or receiver devices. In the figure, one of the proximity credit transfer devices is configured as a sender device 20S, for transferring credits 14 to another device that is configured as a receiver device 20R.

The receiver device 20R must be located within a proximity distance d of the sender device 20S for the receiver device 20R to receive the credits 14 from the sender device 20S. The proximity distance d is one meter or less. However, multiple receiver devices 20S could be within the proximity distance d to the sender device 20S.

To ensure that the intended receiver device 20R device 20S receives the credits 14, the sender device 20S executes a pairing process. The sender device 20S begins the pairing process in response to detecting a physical impact at the body 22 of the sender device 20S.

The pairing process is executed by the server device 20S and determines the receiver device 20R that is in closest physical proximity to the sender device 20S. The receiver device 20R determined to be in closest proximity to the sender device 20S is also known as a paired receiver device 20R′. The receiver devices 20R must be within the proximity distance d to the sender device 20S during the pairing process.

The sender device 20S then creates an encrypted point-to-point link 77 with the paired receiver device 20R′, and sends a credit transfer request message 78 over the link 77. The request message 78 includes a selected amount of credits 14 at the sender device 20S for transfer to the paired receiver device 20R′. The paired receiver device 20R′ receives the request message 78, increases its credits 14 by the selected amount of credits, and stores the credits 14 within its device data 19, and sends a transaction receipt 88. In response to the receipt 88, the sender device 20S reduces its credits 14 by the selected credit amount and stores the credits 14 to its device data 19.

As a result, the credit management system 10 includes proximity credit transfer devices 20 that each have a body 22, include device data 19 and credits 14 stored within the device data, and a user interface 26. The user interface 26 configures the proximity credit transfer devices 20 as sender devices 20S or receiver devices 20R and selects at least some of the stored credits 14 (“selected credit amount”) at the sender devices 20S. In response to a physical impact detected at the body 22 of a sender device 20S, the sender device 20S pairs a receiver device 20R that is in closest proximity to the sender device 20S, and creates an encrypted point-to-point wireless link 77 with the paired receiver device 20R′ and transfers the selected credit amount over the link 77 to the paired receiver device 20R′.

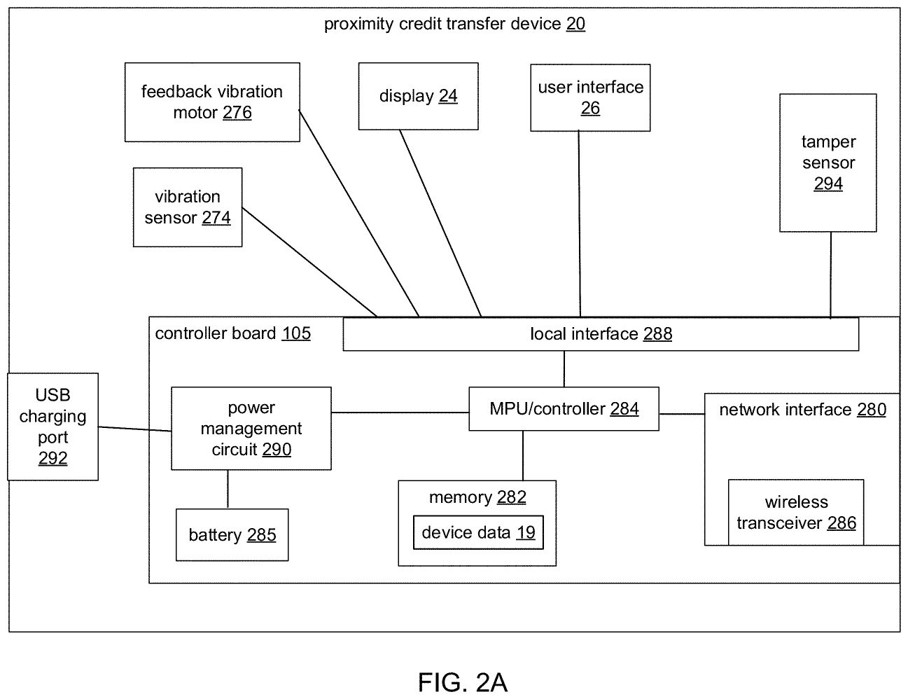

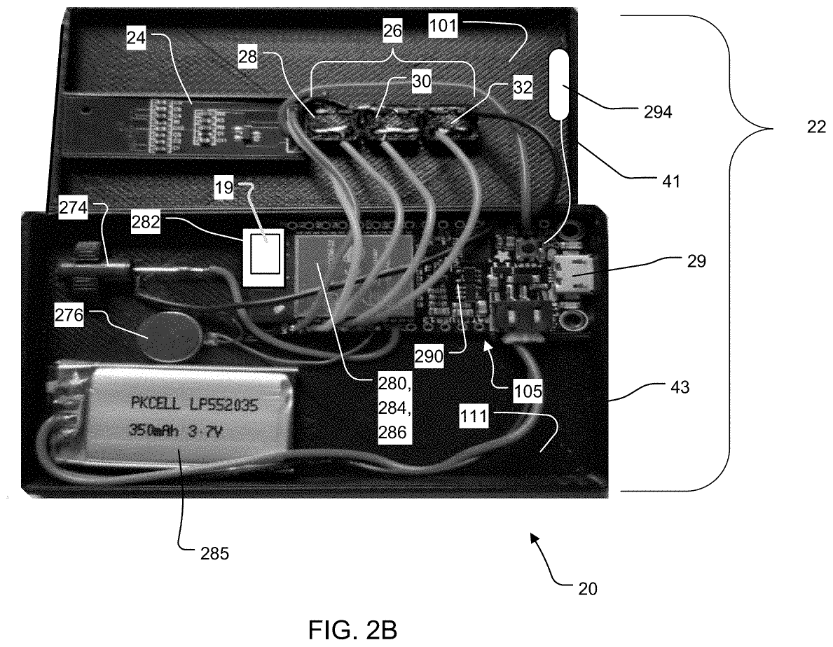

FIG. 2A shows more detail for an exemplary low power proximity credit transfer device 20 in FIG. 1. The low power proximity credit transfer device 20 includes a controller board 105 and various components that communicate with or otherwise connect to the controller board 105.

In more detail, the controller board 105 includes a power management circuit 290, a battery 285, a memory 282, a network interface 280, a local interface 288 and a MPU (here, a microcontroller 284). The controller 284 connects to and controls the power management circuit 290, the memory 282, the local interface 288 and the network interface 280.

The power management circuit 290 connects to a USB charging port 292 and the battery 285. The memory 282 is non-volatile memory and stores the device data 19. The network interface includes a wireless transceiver 286. In one example, the transceiver 28 is a Bluetooth BLE transceiver. Preferably, the battery 285 is rechargeable. In examples, the battery 285 is a lithium-ion battery or a nickel-cadmium battery.

Various components of the device 20 connect to controller board 105 via the local interface 288. These components include one or more impact sensing devices such as a vibration/impact sensor 274, a haptic feedback vibration motor 276, a display 24, a user interface 26, and a tamper sensor 294. Haptic technology, also known as kinesthetic communication or 3D touch, refers to any technology that can create an experience of touch by applying forces, vibrations, or motions to the user.

The user interface 26 includes various buttons. The individual 21 carrying the device 20 activates and configures the device 20 via the buttons. An up button 28, a main button 30, and a down button 32 are shown.

In one implementation, as shown, the controller 284 is a microprocessor MPU that communicates with/connects to external memory 282 and I/O via the network interface 280 and the local interface 288. In another implementation, the memory 282 and the network interface 280 are integrated within the same physical package or “chip” as the controller 284. In one implementation, the controller 284 is interrupt-driven in response to receiving interrupts in the form of signals received at the local interface 288. These signals are sent from the vibration/impact sensor 274 and/or the feedback vibration motor 276, the user interface 26, the power management circuit 290, and the tamper sensor 294, in examples.

Each low power proximity credit transfer device 20 generally operates as follows. At startup/initialization, the controller 284 loads application code of an application loaded into the memory 282, and executes the application code. After startup, the controller 284 instructs the power management circuit 290 to enter a low power idle mode. In this mode, the power management circuit 290 disables the display 24, the network interface 280 and its wireless transceiver 286 to conserve power from the battery 285. The wireless transceiver 286 is thus normally disabled upon startup.

After entering low power idle mode, the controller 284 waits to receive an activation signal from the user interface 26. The user interface 26 sends the activation signal in response to configuration of the device 20 by the individual 21. In more detail, using the buttons, the individual 21 configures the device as either a sender device 20S or a receiver device 20R, and the user interface 26 sends the signal to the controller 284 via the local interface 288. Upon reception of this signal at the local interface 288, the controller 284 activates the device by instructing the power management circuit 290 to turn on the display 24 and enters a ‘standby’ mode.

When in standby mode, the controller 284 waits to receive a signal from the one or more impact sensing devices. Of the one or more impact sensing devices, the vibration/impact sensor 274 is a transducer that senses physical impacts upon the body 22, and outputs associated electrical signals in response. In one example, the vibration/impact sensor 274 is an accelerometer. In another example, the vibration/impact sensor 274 is a shock sensor. The vibration/impact sensor 274 sends its output signal to the controller 284 via the local interface 288. The controller 284, upon receiving the signal indicative of the impact, can then turn on the haptic feedback vibration motor 276 for a period of time. This causes the body 22 of the device 20 to vibrate for a period of time.

When the controller 284 receives the indication of the physical impact, the controller 284 transitions to another operational mode based upon how the device is configured. If the device 20 is configured as a sender device 20S, the controller 284 transitions to ‘send mode.’ If the device 20 is configured as a receiver device 20R, the controller 284 transitions to ‘receive mode.’ In both these modes, the controller 284 instructs the power management circuit 290 to enable the network interface 280 and its wireless transceiver 286. In this way, both sender devices 20S and receiver devices 20R are now able to both listen for and to transmit wireless messages.

As a result, for each of the proximity credit transfer devices 20, the one or more impact sensing devices detect impacts at the body 22 of the device 20 and send signals indicating the impacts to the MPU/controller 294. The MPU/controller 294 enables the normally disabled wireless transceiver 286 upon receiving the signals indicating the impacts.

At any time after startup, the controller 284 also waits to receive signals from the tamper sensor 294. As its name implies, the tamper sensor 294 detects tampering events upon the body 22 of the device 20, and sends a tamper signal in response. Upon receiving the tamper signal, the controller 284 disables the user interface 26 and the display for a lockout period, and then transitions the device 20 to low power idle mode. In one example, the lockout period is three (3) minutes.

Also after startup, the power management circuit 284 waits to receive signals from the USB charging port 292. In one example, the USB charging port 292 is universal serial bus (USB) compatible. In response to detecting power signals at the USB charging port 292, the power management circuit 284 sends power sensing signals to the local interface 288. The controller 284 receives the power sensing signals at the local interface 288 and places the device 20 in a charging mode until power is removed from the USB charging port 292. The port 292 can also be used during a flash upgrade process.

The proximity credit transfer device 20 is also flash upgradable. Specifically, in one example, the device's internal software/firmware can be upgraded over time. For this purpose, the device 20 can accept the upgrades via its USB charging port 292 or via Over the Air Transmission “OTA.” The OTA upgrades can occur when the device 20 is connected to a valid wireless network, such as a WiFi network.

Other examples of MPUs include Digital Signal Processors (DSPs), Application Specific Integrated Circuits (ASICs), and Field Programmable Gate Arrays (FPGAs). The DSPs are pre-programmed, special-purpose microprocessors optimized for the requirements of digital signal processing. The ASICs are MPUs that are pre-programmed and optimized for particular purposes such as image processing, video encoding and decoding, and cellular communications. The DSPs, the ASICs, and the FPGAs have internal logic/application code in the form of an executable image file. The image file of the DSPs and the ASICs have fixed image files, while the FPGAs allow the end user to iteratively replace the image file to customize, test, and reprogram its internal logic/application code. As compared to FPGAs, which seek a tradeoff between performance and the ability of the end user to reprogram, DSPs and ASICs typically have a small footprint, lower power consumption, can operate at higher frequencies, and provide high performance than FPGAs.

FIG. 2B shows a working prototype of the low power proximity credit transfer devices 20S, 20R in FIG. 1. Here, the cover 41 of the body 22 is removed from a base 43 of the body 22 to reveal the components of the device 20. The display 24 seats within a removed portion of the cover 41 to enable the individuals 21 to see the visual portion of the display 24.

In the figure, the display 24, the user interface 26 and its buttons 28, 30, 32 and the tamper device 294 are fastened to an inside surface 101 of the cover 41. The controller board 105, the vibration sensor 274, the feedback vibration motor 276 and the battery 285 are fastened to an inside surface 111 of the base 43. Here, the memory 282 and its device data 19 are populated on the controller board 105.

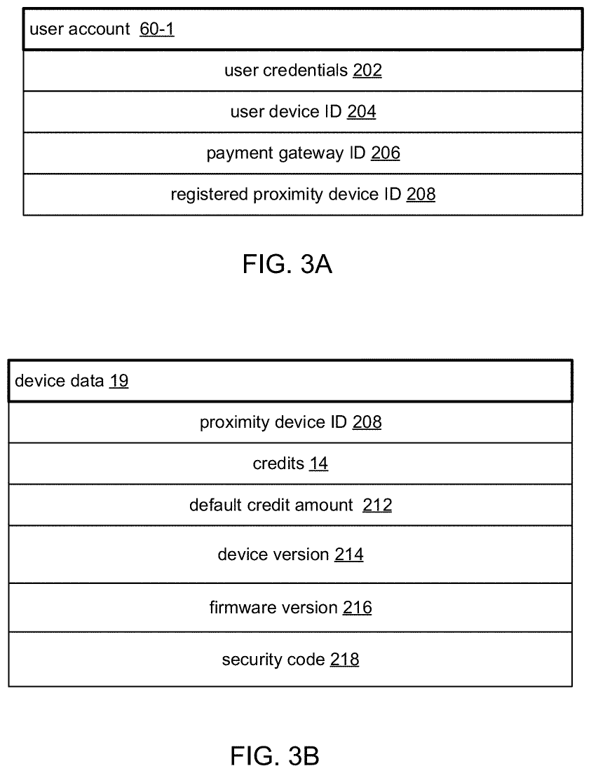

FIG. 3A shows more detail for an exemplary user account 60-1 for an individual/user 21 of the credit management system 10. The user account 60-1 includes various data fields such as user credentials 202, a user device ID 204, a payment gateway ID 206, and a registered proximity device ID 208′.

The data fields of the user account 60-1 are populated via a registration process. The registration process is typically carried out by the administrator of the credit management system 10 at the authorization server 54. The registration process associates/registers a proximity credit transfer device 20 with a particular individual 21 and network connected user device 70 carried by the individual 21. As a result of the registration process, the individuals 21 carrying the network connected user devices 70 and the associated proximity credit transfer devices 20 are authorized users of the system 10.

The user credentials 202 identify the individual 21 and can be in various forms. The user credentials 202 include a username/password, and a biological identifier such as a fingerprint or iris scan, in examples. The user device ID 204 identifies the network connected user device 70 and is typically a media access control (MAC) address of the device 70. The payment gateway ID identifies the payment gateway 206 (e.g. its MAC address) that the administrator has selected. The registered proximity device ID 208′ identifies the proximity credit transfer device 20 that the administrator has registered for the network connected user device 70 carried by the individual 21.

FIG. 3B shows more detail for an instance of device data 19 stored in the memory 282 of a proximity credit transfer device 20. The device data 19 includes a proximity device ID 208, the stored credits 14, a default credit amount 212, a device version 214, a firmware version 216, and a security code 218.

The credits 14 stored on each of the proximity credit transfer devices 20 have various characteristics. They are numerical in nature, but their intrinsic value is assigned/ascribed external to the devices 20, by the administrator of the system. For this purpose, in one implementation, the administrator defines an exchange value at the web API service 48 for the credits. The exchange value associates each credit with a particular type and amount of currency. This agreed-upon value for each of the credits can be expressed in terms of one or more currencies, such as in United States or Canadian dollars, Euros of the European Union, Mexican pesos, South African Rands, Brazilian Reals and Japanese yen, in examples.

The proximity device ID 208 includes a media access control (MAC) address of an IEEE 802.11 compliant wireless transceiver 286 of each device, and additional information prepended and/or appended to the MAC address. The MAC address is “etched” into the memory 282 and thus cannot be tampered with or manipulated after manufacturing. The additional information is specific to the system 10 and is added to ensure that only proximity credit transfer devices 20 can communicate with each other and exchange information.

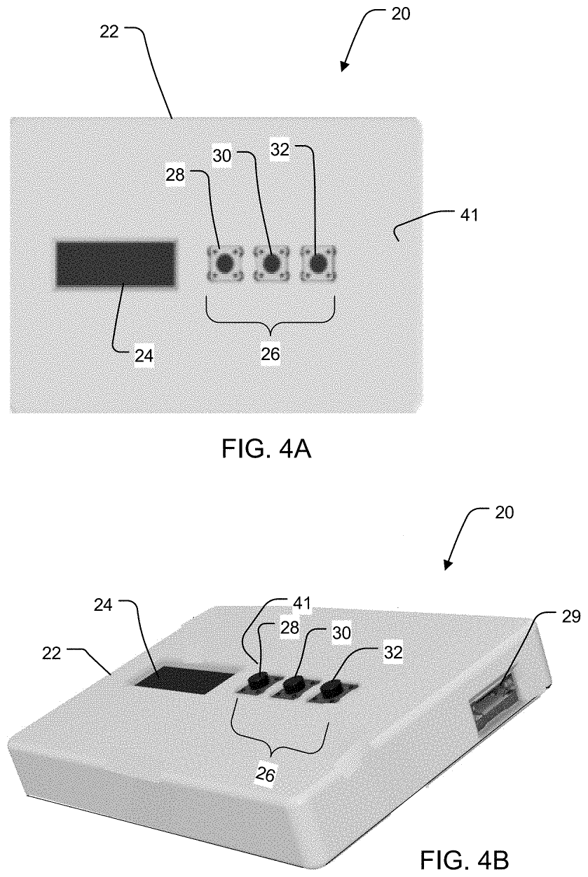

FIGS. 4A and 4B are respectively top and perspective views of the low-power proximity credit transfer devices 20 in FIG. 1. The perspective view of FIG. 4B allows the viewer to see that the buttons 28, 30, and 32 of the user interface 26 extend through openings in the cover 41. In one implementation, the buttons are mechanical ‘tactile’ buttons.

It can also be appreciated that the user interface 26 could be implemented in other ways. In one example, the user interface 26 could be “softkeys” integrated within the display 24. In another example, the user interface 26 could be a graphical user interface (GUI) presented to the display 24 by the application code executing on the controller 284.

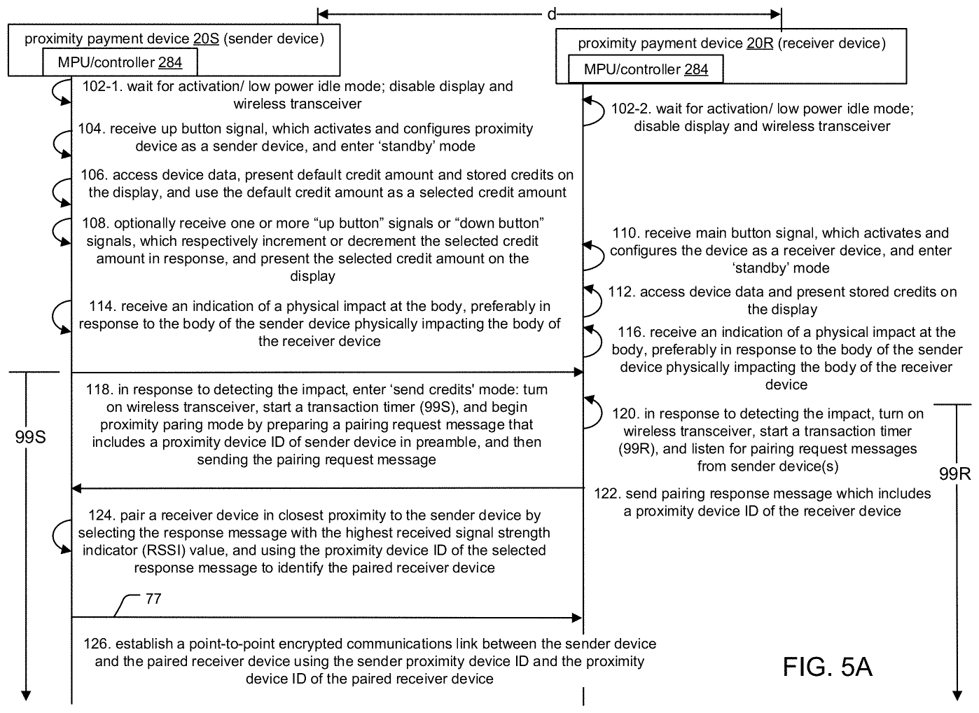

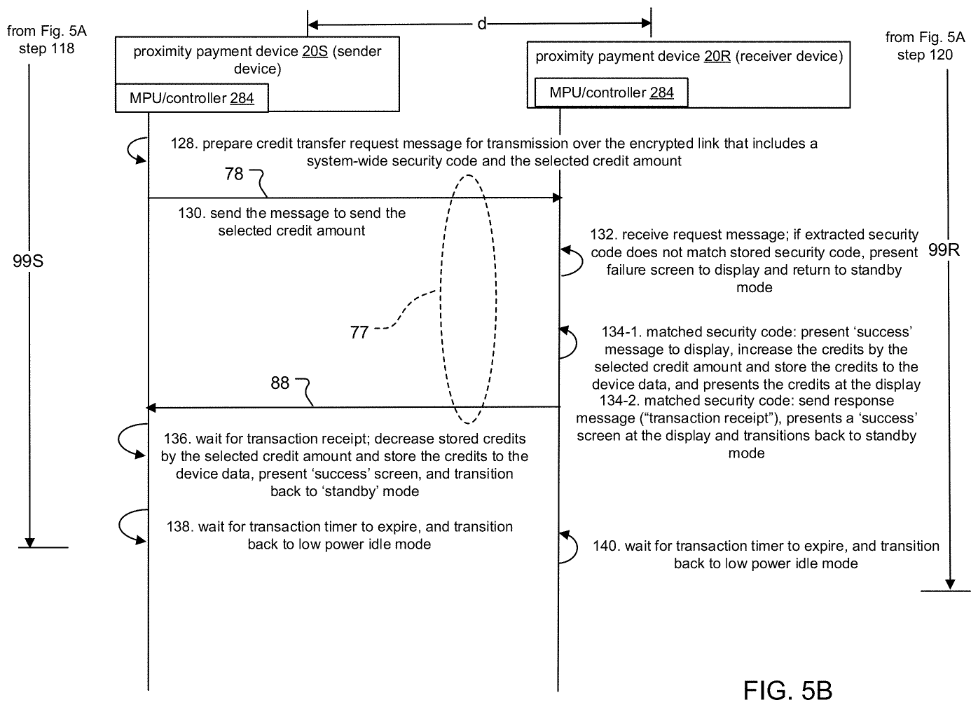

FIGS. 5A and 5B illustrate a credit transfer method of the credit management system 10 in FIG. 1. Communications between two low power proximity credit transfer devices 20 are shown. One of the devices is configured as a sender device 20S and the other is configured as a receiver device 20R.

The method at least describes: configuring a low power proximity credit transfer device as a sender device and at least one low power proximity credit transfer device as a receiver device; a pairing process for pairing the sender device to the receiver device; and transferring of at least some of the credits stored at the sender device to the paired receiver device. The method starts at steps 102-1 and 102-2.

In step 102-1 and 102-2, the two proximity credit transfer devices 20 are in low power idle mode and are awaiting activation. At this point, neither of the devices 20 are configured as sender devices 20S or receiver devices 20R. The displays 24 and the wireless transceivers 286 of the devices 20 are disabled. This provides additional security from fraudulent signal processing and minimizes drain on the batteries 285.

According to step 104, the controller 284 of the left-most device 20 in the figure receives an up button signal. The controller 284 receives the up button signal in response to the individual 21 pressing the up button 28 of the user interface 26. In response, the controller 284 activates and configures the device as a sender device 20S, and enters ‘standby’ mode.

In step 106, the sender device 20S accesses its device data 19, presents the default credit amount 212 and its (stored) credits 14 on the display 24, and uses the default credit amount 212 as a selected credit amount. In step 108, the controller 284 of the sender device 20S optionally receives one or more “up button” signals or “down button” signals, which respectively increment or decrement the selected credit amount in response, and present the selected credit amount on the display 24. The controller 284 receives these signals in response to the individual 21 pressing the up button 28 and the down button 32, respectively.

Then, in step 110, the controller 284 of the right-most device 20 in the figure receives a main button signal. The controller 284 receives the main button signal in response to the individual 21 pressing the main button 30. The controller 284 activates and configures the device as a receiver device 20R, and enters ‘standby’ mode. In step 112, the receiver device 20R accesses its device data 19 and presents the (stored) credits 14 on the display 24.

The controller 284 of the sender device 20S, in step 114, then receives an indication of a physical impact detected at the body 22. The indication is in the form of signals sent from the one or more impact sensing devices (e.g. the vibration sensor 274 and/or the feedback vibration motor 274).

In a similar vein, in step 116, the receiver device 20R receives an indication of a physical impact at its body 22. Preferably, the impacts detected at the bodies 14 of both the sender device 20S and the receiver device 20R in steps 114 and 116 are in response to the body 22 of the sender device 20S physically impacting the body of the receiver device 20R.

Though multiple receiver devices 20R could be within proximity of the impacted sender device 20S, only impacted receiver devices 20R listen for and respond to the pairing request messages sent from the sender device 20S. As a result, the sender device 20S receives responses to its pairing request message from impacted receiver devices 20R.

According to step 118, in response to detecting the impact, the sender device 20S enters ‘send credits’ mode. Here, the sender device 20S turns on its wireless transceiver 286, starts a transaction timer 99S, and begins a proximity paring mode by preparing a pairing request message. The message includes a proximity device ID of the sender device 20S in a preamble of the message. The sender device 20S then sends the pairing request message via its network interface 280/wireless transceiver 286 for reception by one or more receiver devices 20R that are in proximity to (i.e. are within the proximity distance d of) the sender device 20S.

It is important to note that the sender device 20S begins the pairing process only after detecting the physical impact upon its body 22. The wireless transceiver 286 of the sender device 20S is in a normally disabled state prior to detecting the impact. As a result, the sender 20S and receiver devices 20R are unknown/not paired to each other prior to the detecting of the impact. Once the sender device 20S detects the impact, the sender device 20S enables its wireless transceiver 286, and the pairing process can begin. This is in contrast to the persistent pairing as typically known for conventional Bluetooth device pairing.

In one implementation, the communications between the sender device 20S and the paired receiver device 20R′ are achieved via a 2.4 GHz wireless communication proprietary protocol that provides a fast, connectionless transfer of data with very low power usage and many benefits. The protocol uses the IEEE 802.11 Action Vendor frame technology, along with optional encryption technology to provide a secure, connectionless communication solution. In examples, the encryption technology is based upon Counter Mode with Cipher Block Chaining Message Protocol (CCMP), or older wireless encryption technologies. The device to device communication protocol supports encrypted and unencrypted unicast communication and mixed encrypted and unencrypted peer devices. This protocol can transport up to 250 bytes of payload per transmission. The device to device protocol has robust sending callback functions that inform the application layer of transmission success or failure.

Similarly, in step 120, the receiver device 20R executes various tasks in response to detecting the impact at its body 22. The controller 284 turns on the wireless transceiver 286, starts a transaction timer 99R, and the wireless transceiver 286 listens for the pairing request messages sent from the sender device(s) 20S. According to step 122, one or more receiver devices 20S in proximity to the sender device 20S send pairing response messages to the sender device 20S. The response messages include the proximity device IDs 208 of the receiver devices 20R.

It is also important to note that the various receiver devices 20R do not participate in the pairing process until the receiver devices 20R detect physical impacts upon their bodies 22. As with the sender devices 20S, the receiver devices 20R do not enable their normally disabled wireless transceivers 286 until detecting the physical impacts upon their bodies 22. This is in contrast to the persistent pairing as typically known for conventional Bluetooth device pairing.

Then, in step 124, the sender device 20S pairs a receiver device 20R in closest proximity to the sender device 20S by selecting the response message with the highest received signal strength indicator (RSSI) value, and using the proximity device ID 208 of the selected response message to identify the paired receiver device 20R′. In this way, the sender device 20S filters the list of receiver devices 20R by the RSSI level 24 to ensure that the pairing is performed with the receiver device 20R in closest proximity to the sender device 20S.

In one example, the proximity device IDs 208 include service set identifier (SSID) values of the proximity transfer credit devices 20, in conjunction with other values that unique to the devices 20. When the closest found receiver device 20R is determined, the MAC address of the device 20R is directly bound to the transaction communications.

The devices 20S, 20R are preferably impacted against each other in steps 114 and 116 so that the sender device 20S most likely selects the receiver device 20R that came into contact with the sender device 20S as the paired receiver device 20R′.

The sender device 20S in step 126 then establishes a point-to-point communications link 77 between the sender device 20S and the paired receiver device 20R′ using the proximity device ID of the sender device 20S and the proximity device ID of the paired receiver device 20R′. Preferably, the link 77 is encrypted, but can also be unencrypted.

The sender device 20S and the paired receiver device 20R′ as endpoints of the encrypted point-to-point link 77 then exchange various messages over the link 77. Prior to transmitting the messages the endpoints 20S, 20R′ encrypt the contents of the messages. Upon receiving the messages, the endpoints 20S, 20R′ decrypt the messages and extract their contents.

The method continues in FIG. 5B.

In FIG. 5B, step 128, the sender device 20S prepares a credit transfer request message 78 for transmission over the encrypted link 77. The message includes a system-wide security code 218 and the selected credit amount. In one implementation, the security code 218 is a system-wide value that is pre-configured by the administrator and stored to the device data 19 of all proximity credit transfer devices 20 registered with the system 10. The sender device 20S then sends the request message 78 over the link 77 to send the selected credit amount to the paired receiver device 20R′ in step 130.

The paired receiver device 20R′ must successfully process the contents of the request message 78 in order to transfer the selected amount of credits in the message 78 to the paired receiver device 20R′.

In step 132, the receiver device 20R receives the request message 78 and extracts its contents. If the extracted security code does not match the stored security code 218 at the receiver device 20R, the receiver device 20R presents a failure screen to its display 24 and returns to ‘standby’ mode. If there is a match, the receiver device 20R transitions to steps 134-1 and 134-2.

In step 134-1, the receiver device 20R presents a ‘success’ message to its display 24, increases its credits 14 by the selected credit amount and stores the credits 14 to its device data 19, and presents the credits 14 at the display 24. In step 134-2, the receiver device 20R then sends a response message in the form of a transaction receipt 88 to the sender device 20S, presents a ‘success’ screen to the display 24, and transitions back to ‘standby’ mode.

In step 136, the sender device 20S waits for the transaction receipt 88. In response to receiving the transaction receipt 88, the sender device 20S decreases its stored credits 14 by the selected credit amount and stores the credits 14 to the device data 19, presents a ‘success’ screen to the display 24, and transitions back to ‘standby’ mode. The sender device 20S in step 138 then waits for the transaction timer 99S to expire and transitions back to low power idle mode.

After detecting the physical impacts at the devices 20S/20R, each of the devices 20S/20R start their respective transaction timers 99S/99R. The transaction timers 99 are used by the controllers 284 of the devices 20S/20R to control an event window time period over which a transaction can occur. If any communication is attempted with the devices 20S/20R beyond their respective event windows, the messages/communication are ignored. In addition, the entire wireless communication system (e.g. the wireless transceivers 286 of the devices 20S/20R) are disabled outside of this window, rendering the device invisible to other signal processing devices and are therefore unable to transmit or receive data.

Both the sender device 20S and the paired receiver device 20R′ must then remain within the proximity distance d for their respective event windows in order for the transfer of the credits 14 to be successful. In examples, the event window can be as short as 500 milliseconds (mSec) or as long as three (3) seconds. To determine whether the devices 20S/20R remain within the proximity distance d for the event window, the devices 20S/20R periodically compare the values of their transaction timers 99S/99R to the event window. The devices 20S, 20R′ also reject the credit transfer if the transaction timers 99S, 99R exceed the event window.

Banking Institution Transactions

A designated banking institution 58 and payment gateway 56 of the payment system 90 are accessed by the credit management system 10 for the issuance and remittance of the credits 14 stored on the proximity credit transfer devices 20. Specifically, a propagation method of the credit management system 10 is illustrated in FIG. 6, and a redemption method of the system 10 is illustrated in FIG. 7.

FIG. 6 shows a propagation method of the credit management system 10 in FIG. 1. The method describes how an individual 21 can purchase credits 14 at an application 12 running on a network connected user device 70, and then propagate the credits to a low power proximity credit transfer device 20 associated with the same individual 21. Via the application 12 running on the network connected user device 70 carried by the individual 21, the individual 21 purchases credits 14 from the banking institution 58, via a communications path that includes the application 12, the web API service 48, the payment gateway 56, and finally the banking institution 58. The number of credits purchased is then returned back along this path to the a low power proximity credit transfer device 20, which updates its stored credits 14 by the purchased number of credits.

In the illustrated example, the network connected user device 70 is in communication with a proximity credit transfer device 20 that is configured as the sender device 20S. However, this method operates upon all low power proximity credit transfer devices 20, regardless of whether they are configured as sender or receiver devices 20S/20R.

In the steps below, various components such as the application 12, the network connected user device 70, the web API service 48, the proximity credit transfer device 20, the authorization service 54, and the payment gateway 56 exchange messages. Preferably, the messages are encrypted.

In step 502, the application 12 executing on the network connected user device 70 receives user credentials 202 entered by the user/individual 21. In step 504, the application 12 sends a login request message to the authorization server 54. The login request includes the user credentials 202 and the user device ID 504 (e.g. MAC address) of the network connected user device 70.

According to step 506, the authorization server 54 extracts the contents of the login request message, and obtains the user account 60 for the individual 21 using the user device ID extracted from the login request message as a key/index. If the user account 60 is found, the server 54 determines if the individual 21 is an authorized user of the system 10 by matching the extracted user credentials 202 to those stored in the user account 60. If the individual 21 is an authorized user (the user credentials match), in step 508, the authorization server 54 sends the registered proximity device ID 208′ stored in the user account 60 back to the application 12.

In step 510, the application 12 determines whether the proximity credit transfer device nearest to and in communication with the network connected user device 70 is registered to that network connected user device 70 (and thus to the individual 21 that is carrying the network connected user device 70). For this purpose, the application 12 requests the device data 19 of the proximity credit transfer device (here, sender device 20S) and verifies that the proximity device ID 208 in the device data 19 matches the registered proximity device ID 208′ sent from the authorization server 54 in step 508.

If a match in step 510, the application 12 in step 512 prompts the individual 21 to enter an account number or credit card number, a requested number of credits 14 to purchase, and login credentials for both the web API service 48 and the payment gateway 56. Alternatively, the account number or credit card number and the login credentials for both the web API service 48 and the payment gateway 56 can be previously stored within the application 12. Then, in step 514, the application 12 sends a credit to currency exchange value message to the web API service 48. The message includes the requested number of credits 14 to purchase and the login credentials for the web API service 48.

In step 516, the web API service 48 receives the request and verifies that the request is from an authorized user by comparing the received login credentials to its stored login credentials. If an authorized user, the web service API 48 returns the price, in pre-defined/agreed upon currency units, for the requested number of credits to be purchased.

According to step 518, the application 12 receives the price for the amount of credits to purchase from the web API service 48, and prepares a credit purchase transaction message. This message includes payment information (e.g. account number/credit card number and price for the amount of credits to purchase), and the login credentials for access to both the web API service 48 and the payment gateway 56. The application 12 then sends the message to the web API service 48.

In step 520, the web API service 48 receives the credit purchase transaction message, and extracts its contents. The web API service 48 then sends the extracted information in a message to the payment gateway 56 to present the information for payment at the payment gateway 56.

At the payment gateway, in step 522, the gateway 522 verifies if the request is from an authorized user based upon the login credentials, verifies the payment information, and completes the payment transaction with the banking institution 58. In step 524, the payment gateway 56 sends a message indicating success or failure of the transaction to the wen API service 48, and includes the number of credits purchased if successful. The web API service 48 sends the number of credits purchased (if successful).

At step 528, the application 12 accesses the copy of the device data 19 obtained from the sender device 20S in step 510. The application 12 increases the stored credits 14 from the copy of the device data 19 with the purchased credits. In step 530, the application 12 sends an update message that includes the new/updated credits 14 to the sender device 20S. The sender device 20S receives the update message in step 532, replaces its stored credits 14 in its device data 19 with the new/updated value, presents the stored credits 14 on its display 24, and transitions to ‘standby’ mode.

FIG. 7 shows a redemption method of the credit management system 10 in FIG. 1. The method describes how an individual 21 can use the application 10 running on the network connected user device 70 to select and extract credits 14 stored at a low power proximity credit transfer device 20 for redemption at a banking institution 58. The redemption method is effectively the reverse of the propagation method in FIG. 6.

In the illustrated example, as in FIG. 6, the network connected user device 70 is in communication with a proximity credit transfer device 20 that is configured as the sender device 20S. However, this method operates upon all low power proximity credit transfer devices 20, regardless of whether they are configured as sender or receiver devices 20S/20R.

In the steps below, various components such as the application 12, the network connected user device 70, the web API service 48, the proximity credit transfer device 20, the authorization service 54, and the payment gateway 56 exchange messages. Preferably, the messages are encrypted.

Steps 502 through 510 are identical to the same steps in FIG. 6.

If a match for the proximity device ID is found in step 510, indicating that the sender device 20S and the network connected user device 70 are properly registered/paired with one another, the method transitions to step 540. In step 540, the application 12 prompts the individual 21 to an account number or credit card number and an amount of credits to redeem, and to enter login credentials for both the web API service and the payment gateway. Alternatively, the account number or credit card number and the login credentials for both the web API service 48 and the payment gateway 56 can be previously stored within the application 12.

According to step 542, the application 12 prepares a redemption request message that includes the number of credits requested for redemption, and sends the request to the sender device 20S. In step 544, the sender device 20S verifies that the requested number of credits are available, and sends an indication to this effect. Alternatively, the application 12 could first query the sender device 20S for its stored credits 14, and then send the redemption request message.

According to step 544, the application prepares a credit redemption transaction message. This message includes the account number/credit card number and number of the credits requested for redemption, and the login credentials for access to both the web API service 48 and the payment gateway 56. The application 12 then sends the message to the web API service 48.

In step 546, the web API service 48 receives the credit redemption transaction message and extracts its contents. The web API service 48 then verifies if the request is from an authorized user based upon the received login credentials and converts the requested amount of credits to redeem to an agreed-upon value in a specific currency. The web API service then prepares a message that includes the (redeemed) value, the account number/credit card information, and the payment gateway login credentials. The web API service 48 sends the message to the payment gateway 56 to present the information for redemption at the payment gateway 56.

At the payment gateway, in step 548, the gateway 56 verifies if the request is from an authorized user based upon the received login credentials, verifies the account/credit card information, and completes the redemption transaction with the banking institution 58. In step 550, the payment gateway 56 sends a message indicating success or failure of the transaction to the web API service 48, and includes the value redeemed if successful. In case the value actually redeemed is different from the requested amount, the web API service 48 converts the redeemed value to credits 14, and sends the number of credits 14 redeemed (if successful).

At step 554, the application 12 accesses the copy of the device data 19 obtained from the sender device 20S in step 510. The application 12 decrease the stored credits 14 from the copy of the device data 19 by the number of redeemed credits. In step 556, the application 12 sends an update message that includes the updated stored credits 14 to the sender device 20S. The sender device 20S receives the update message in step 560, replaces its stored credits 14 in its device data 19 with the new/updated value, presents the stored credits 14 on its display 24, and transitions to ‘standby’ mode.

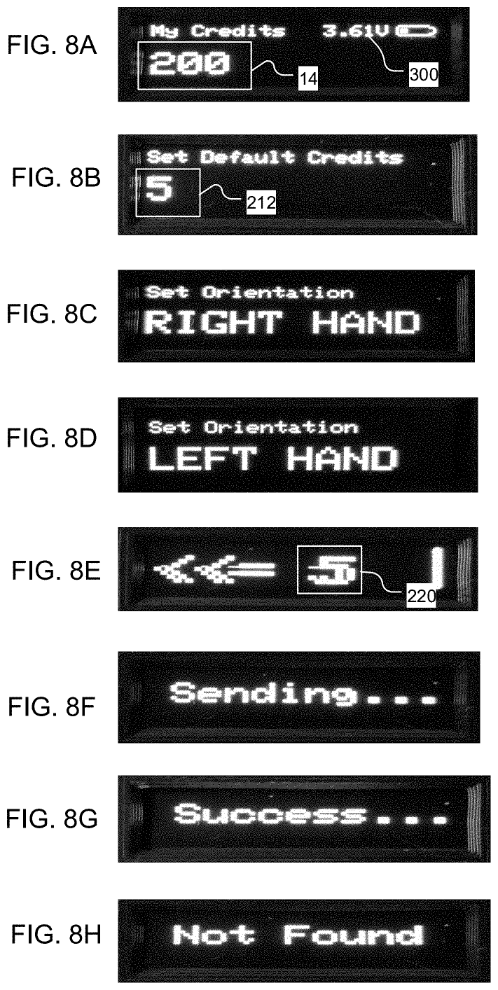

FIG. 8A through 8H show different display screens that the low power proximity credit transfer devices 20 in FIG. 1 present to their displays 24. The proximity credit transfer devices 20 display these screens during different operational modes of the devices 20.

FIG. 8A is a ‘standby screen’ that is displayed when the devices 20 are in standby mode. A charge level 300 of the battery 285 and the number of stored credits 14 are displayed.

FIG. 8B is a ‘default credits screen’ that is displayed when the devices 20 are in a default credits mode. To enter this mode, in one example, the device 20 is currently in ‘standby’ mode, and the individual 21 selects both the up button 28 and the down button 32 at substantially the same time. The individual 21 can then use the up button 28 or down button 32 to incrementally increase or decrease the selected amount of credits for transfer, respectively. After a timeout period, the device 20 transitions back to ‘standby’ mode.

FIGS. 8C and 8D are ‘device orientation screens’ that are displayed when the device 20S is in an orientation mode. The device 20S must currently be in default credits mode in order to enter the orientation mode. To enter the orientation mode, the individual 21 presses the main button 30 while in default credits mode. The user can toggle the device screen orientation from right hand orientation (FIG. 8C) to left hand orientation (FIG. 8D) by selecting the up button 28 or the down button 32.

In right-handed orientation, the buttons are located toward a right-most side of the body 22 of the device 20S and the display 24 is located to the left-most side of the body 22. In left-handed orientation, the buttons are located toward the left-most side of the body 22 of the device 20S and the display 24 is located to the right-most side of the body 22. Pressing the main button 30 while the orientation screen is rendered returns the device to the standby mode/standby screen of FIG. 8A.

FIG. 8E is a ‘credit transfer screen’ that is displayed when the individual 21 has committed to a selected amount of credits for transfer. The selected number of credits for transfer 220 is displayed.

FIG. 8F is a ‘sending’ screen that is displayed during the transfer of the credits 14 from the sender device 20S to the paired receiver device 20R′.

FIG. 8G is a ‘success’ screen that both the sender device 20S and the paired receiver device 20R′ display upon a successful transfer of credits. See steps 134-1 and 136 in FIG. 5B for the displaying of this screen at the paired receiver device 20R′ and the sender device 20S, respectively.

FIG. 8H is a ‘failure’ screen that both the sender device 20S and the paired receiver device 20R′ display in response various messaging or operational failures encountered during the credit transfer method.

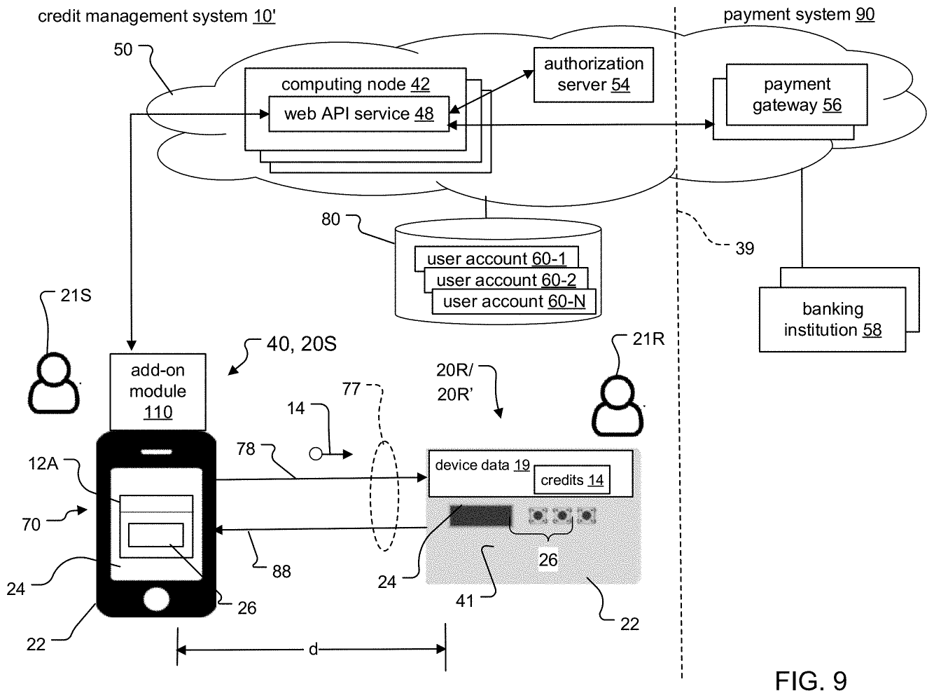

FIG. 9 shows another exemplary credit management system 10′ that is in communication with a payment system 90. The credit management system 10′ operates in a substantially similar manner as that in FIG. 1, and includes substantially similar components.

In the illustrated example, a network connected user device 70 (here, a smartphone) has been adapted in various particulars to additionally operate as a proximity credit transfer device 20. The combined network connected user device 70/proximity credit transfer device 20 is indicated by reference numeral 40 and is hereinafter referred to as a network connected proximity credit transfer device 40.

The network connected proximity credit transfer device 40 accepts the add-on module 110, has a body 22 and includes various components. These components include one or more applications 12A and a display 24. The applications 12A include a user interface 26 (here, a graphical user interface) that is implemented by the application code of the application 12A. The application 12A presents the GUI 26 on the display 24.

Here, the network connected proximity credit transfer device 40 is configured as a sender device 20S, and is in direct communications with the network cloud 50 and a low power proximity credit transfer device 20 that is configured as a receiver device 20R.

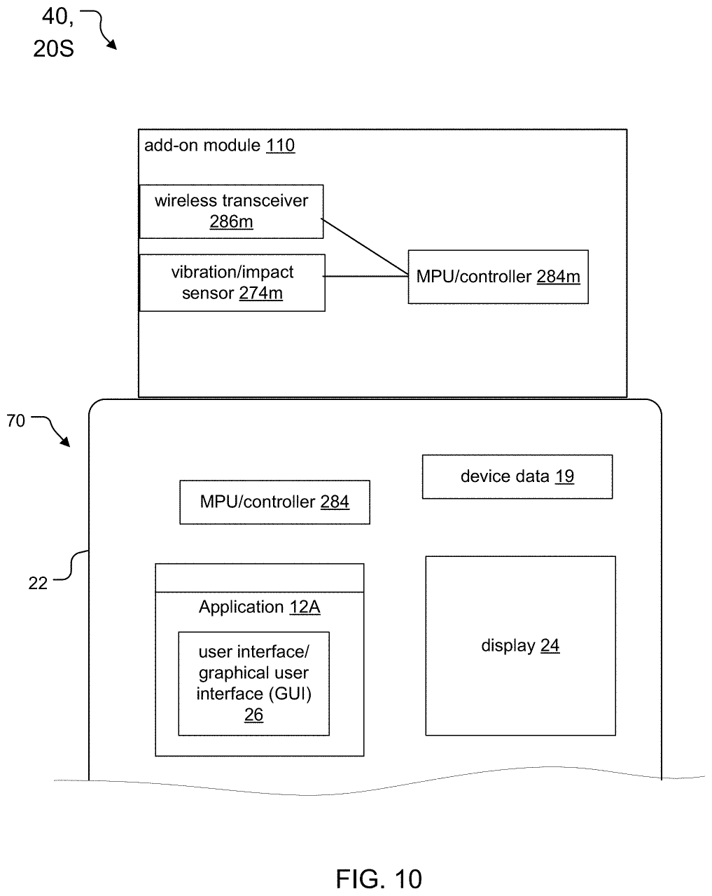

FIG. 10 shows more detail for the network connected proximity credit transfer device 40 in FIG. 9.

Many network connected user devices 70 include an auxiliary port that accept add-on modules 110. Typically, the modules connect to a universal serial bus (USB) capable port on the user devices 70. The add-on module 110 adapts the network connected user devices 70 for operation as proximity credit transfer devices 20.

In the illustrated example, the add-on module 110 connects to a USB port along the body 22 of a network connected user device 70. The combination of the add-on module 110 and the network connected user device 70 is also said to form a network connected proximity credit transfer device 40.

These modules 110 typically utilize/leverage many of the existing capabilities and resources of the network connected user devices 70 to which the modules 110 attach. In examples, the modules 110 usually receive their power from and use the processing/MPU and storage capabililties of the network connected user devices 70.

The module 110 includes various components. These components include one or more impact detection sensors such as a vibration/impact sensor 274m, a local MPU/controller 284m and a dedicated wireless transceiver 286m, in examples. The ‘m’ appended to these references is used to distinguish these components from similar components in the low power proximity credit transfer devices 20, or from similar components that may already exist in the network connected user device 70. It is important to note that the dedicated wireless transceiver 286m and the local controller 284m are independent from any wireless transceivers 286 and MPUs/controllers 284 that are included within the network connected user devices 70.

One or more authorized applications 12A are in communication with the module 110. These applications 12A are used by individuals 21 to configure and manage operation of the user devices 70 and the add-on modules 110. One such application 12A is shown.

The application 12A includes a user interface 26 (here, a graphical user interface, or GUI). The application 12A presents various interactive components of the GUI 26 such as text boxes, menus, windows, buttons, and dialogs, in examples.

The local controller 284m communicates with and controls the one or more impact sensing devices 274m, the dedicated wireless transceiver 286m, and maintains state of the network connected proximity credit transfer device 40. The local controller 284m is also in communication with various components of the network connected user device 70 such as its MPU/controller 284, applications 12A, the device data 19, and the display 24, in examples.

In one implementation, as shown, the network connected proximity credit transfer device 40 stores its device data 19 to non-volatile memory of the network connected user device 70. In another implementation, the network connected proximity credit transfer device 40 might store its device data 19 locally at the add-on module.

Alternatively, the network connected user devices 70 could be modified or originally constructed to include the one or more impact detection sensors 274m and the dedicated wireless transceiver 286m. Thus, the network connected user devices 70 would also operate as network connected proximity credit transfer devices. Here, there would likely be no need for the independent controller 284m. Rather, the existing controller 284 of the network connected user device 70 can control and maintain the various states of the network connected proximity credit transfer device 40.

It is also important to note that the device data 19 stored at the underlying network connected user device 70 is accessible only by the one or more authorized applications 12A. In one example, secure storage of the device data 19 can be achieved via a secure encrypted database included within the network connected user device 70. Various protection schemes are also utilized so that the storage in non-volatile memory for the device data 19 cannot be accessed by other applications. This prevents unauthorized access to or tampering with the stored credits 14.

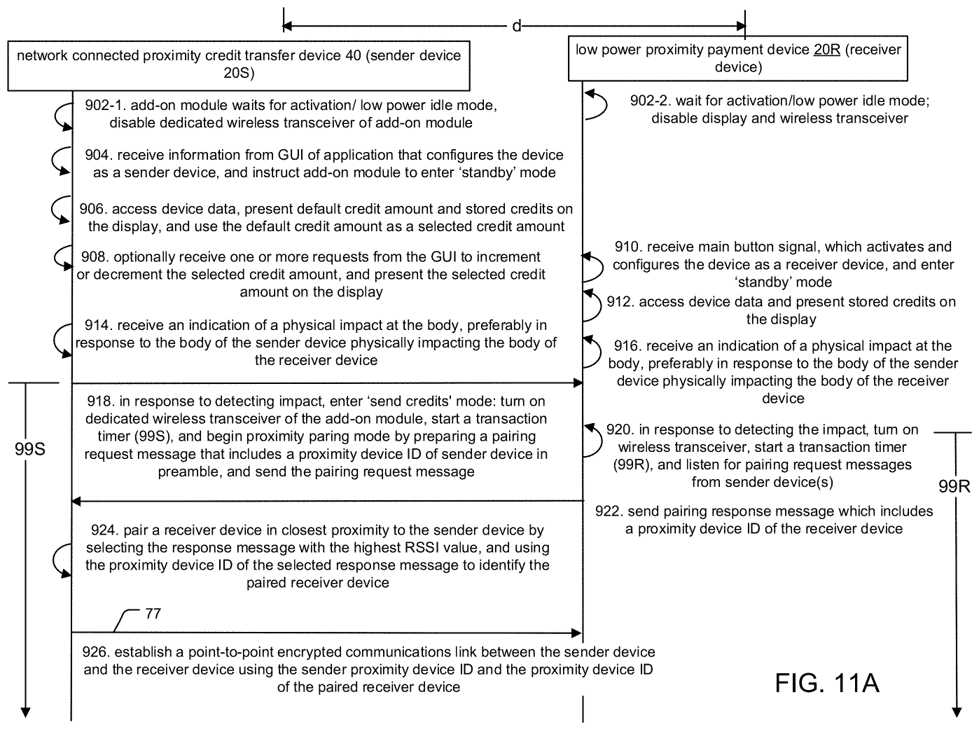

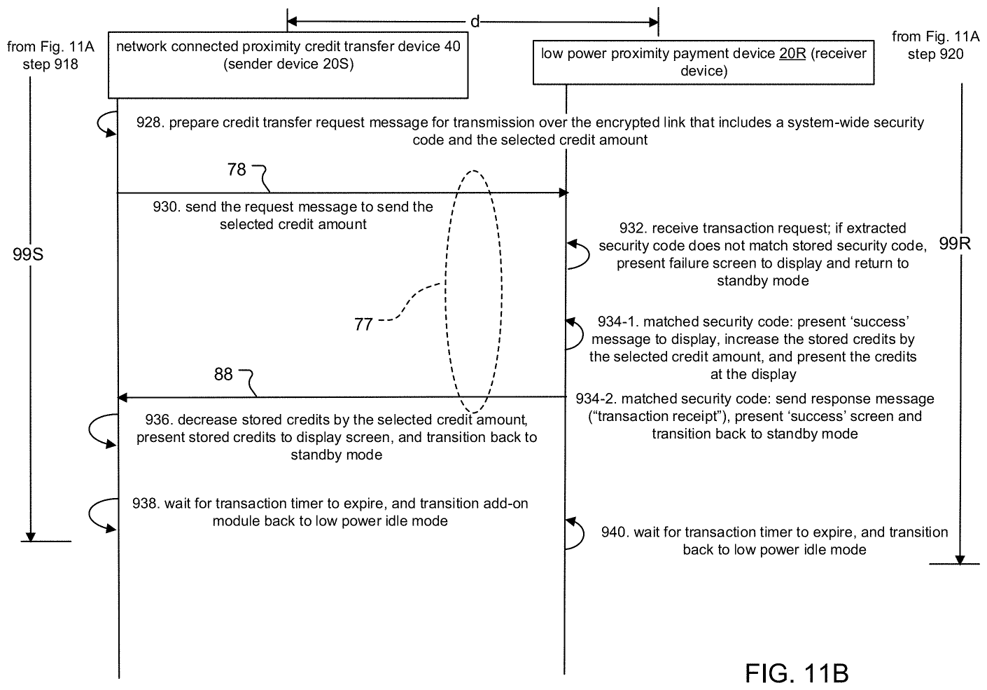

FIGS. 11A and 11B illustrate a method of operation for the credit management system 10′ in FIG. 9. Communications between a network connected proximity credit transfer device 40 and a low power proximity credit transfer device 20 are shown. The network connected proximity credit transfer device 40 is configured as a sender device 20S and the low power proximity credit transfer device 20 is configured as a receiver device 20R.

The method at least describes: configuring a network connected proximity credit transfer device as a sender device; configuring at least one low power proximity credit transfer device as a receiver device; a pairing process for pairing the sender device to the receiver device; and transferring of at least some of the credits stored at the sender device to the paired receiver device.

The method starts at steps 902-1 and 902-2.

In step 902-1, the add-on module 110 of the network connected proximity credit transfer device 40 is in low power idle mode and awaits activation. Its dedicated wireless transceiver 286m is disabled. Similarly, in step 902-2, the low power proximity credit transfer device 20 is in low power idle mode and is awaiting activation. Its display 24 and wireless transceiver 286 are disabled. At this point, neither of the devices 40, 20 are configured as sender devices 20S or receiver devices 20R.

According to step 904, the controller 284m of the network connected proximity credit transfer device 40 receives information from its GUI 26 in response to the individual 21 interacting with the GUI 26. The information configures the device 40 as a sender device 20S. The local controller 284m then transitions the sender device 20S to enter ‘standby’ mode. Then, in step 906, the sender device 20S accesses its device data 19, presents the default credit amount 212 and its (stored) credits 14 on the display 24, and uses the default credit amount 212 as a selected credit amount.

In step 908, the controller 284m of the add-on module 110 optionally receives one or more requests from the GUI 26 to increment or decrement the selected credit amount, and presents the selected credit amount via the GUI 26 on the display 24.

Then, in step 910, the controller 284 of the right-most device 20 in the figure (the low power proximity credit transfer device) receives a main button signal. The controller 284 receives the main button signal in response to the individual 21 pressing the main button 30. The controller 284 activates and configures the device as a receiver device 20R, and enters ‘standby’ mode. In step 912, the receiver device 20R accesses its device data 19 and presents the (stored) credits 14 on the display 24.

At the sender device 20S, in step 914, the controller 284m of the add-on module 110 receives an indication of a physical impact detected at the body 22. The indication is in the form of signals sent from the one or more vibration/impact sensing devices 274m of the add-on module 110.

In a similar vein, in step 916, the receiver device 20R receives an indication of a physical impact at its body 22. Preferably, the impacts detected at the bodies 22 of both the sender device 20S and the receiver device 20R in steps 914 and 916 are in response to the body 22 of the sender device 20S physically impacting the body 22 of the receiver device 20R.

According to step 918, in response to detecting the impact, the sender device 20S enters ‘send credits’ mode. Here, the sender device 20S turns on the dedicated/independent wireless transceiver 286m, starts a transaction timer 99S, and begins a proximity paring mode by preparing a pairing request message. The message includes a proximity device ID of the sender device 20S in a preamble of the message. The sender device 20S then sends the pairing request message via its wireless transceiver 286m for reception by one or more receiver devices 20R that are in proximity to (i.e. are within the proximity distance d of) the sender device 20S.

The sender device 20S uses the dedicated wireless transceiver 286m of the add-on module 110 for all subsequent wireless communications with the receiver device(s) 20R.

Similarly, in step 920, the receiver device 20R executes various tasks in response to detecting the impact at its body 22. The controller 284 turns on its wireless transceiver 286, starts a transaction timer 99R, and the wireless transceiver 286 listens for the pairing request messages sent from the sender device(s) 20S. According to step 920, one or more receiver devices 20S in proximity to the sender device 20S send pairing response messages to the sender device 20S. The response messages include the proximity device IDs 208 of the receiver devices 20R.

Then, in step 924, the sender device 20S pairs a receiver device 20R in closest proximity to the sender device 20S by selecting the response message with the highest received signal strength indicator (RSSI) value, and using the proximity device ID 208 of the selected response message to identify the paired receiver device 20R′.

The devices 20S, 20R are preferably impacted against each other in steps 914 and 916 so that the sender device 20S most likely selects the receiver device 20R that came into contact with the sender device 20S as the paired receiver device 20R′.

The sender device 20S in step 926 then establishes a point-to-point communications link 77 between the sender device 20S and the paired receiver device 20R′ using the proximity device ID of the sender device 20S and the proximity device ID of the paired receiver device 20R′. Preferably, the link 77 is encrypted, but can also be unencrypted.

The sender device 20S and the paired receiver device 20R′ as endpoints of the encrypted point-to-point link 77 then exchange various messages over the link 77. Prior to transmitting the messages the endpoints 20S, 20R′ encrypt the contents of the messages. Upon receiving the messages, the endpoints 20S, 20R′ decrypt the messages and extract their contents.

The method continues in FIG. 11B.

In FIG. 11B, step 928, the sender device 20S prepares a credit transfer request message 78 for transmission over the encrypted link 77. The message includes a system-wide security code 218 and the selected credit amount. The sender device 20S then sends the request message 78 over the link 77 to send the selected credit amount to the paired receiver device 20R′ in step 930. The paired receiver device 20R′ must successfully process the contents of the request message 78 in order to transfer the selected amount of credits in the message 78 to the paired receiver device 20R′.

In step 932, the receiver device 20R receives the request message 78 and extracts its contents. If the extracted security code does not match the stored security code 218 at the receiver device 20R, the receiver device 20R presents a failure screen to its display 24 and returns to ‘standby’ mode. If there is a match, the receiver device 20R transitions to steps 934-1 and 934-2.

In step 934-1, the receiver device 20R presents a ‘success’ message to its display 24, increases its credits 14 by the selected credit amount and stores the credits 14 to its device data 19, and presents the credits 14 at the display 24. In step 934-2, the receiver device 20R then sends a response message in the form of a transaction receipt 88 to the sender device 20S, presents a ‘success’ screen to the display 24, and transitions back to ‘standby’ mode.

In step 936, the sender device 20S waits for the transaction receipt 88. In response to receiving the transaction receipt 88, the sender device 20S decreases its stored credits 14 by the selected credit amount, presents its stored credits to the display 24 via the GUI 26, and transitions back to ‘standby’ mode. The sender device 20S in step 938 then waits for the transaction timer 99S to expire and transitions back to low power idle mode. Similarly, the receiver device 20R in step 940 waits for its transaction timer 99R to expire and transitions back to low power idle mode.

It can also be appreciated that pairs of network connected proximity transfer devices 40 can exchange their credits 40 in a substantially similar manner as that described in FIGS. 11A and 11B.

At the same time, it is important to note that although the network connected proximity transfer devices 40 connect to networks such as the internet, this connection is not required (and is not used) by the network connected proximity transfer devices 40 when pairing the devices 20S/20R′, establishing the wireless encrypted communications link 77, and transferring the credits 14 over the link 77. In this way, just as with the credit transactions between the low power proximity credit transfer devices 20, the network connected proximity transfer devices 40 establish the same anonymous, secure, device-to-device communications between sender devices 20S and receiver devices 20R and transfer credits among devices over the links. The network connected proximity transfer devices 40 do not require an internet connection to accomplish this, and do not require authorization/validation of the transactions by the payment gateways 56.

Propagation and Redemption for the Network Connected Proximity User Devices 40

The network connected proximity user devices 40 propagate and redeem their credits in a substantially similar manner as that illustrated in FIGS. 6 and 7, respectively. The main difference is that the unlike the separate network connected user device 70 and proximity credit transfer device 20S in FIG. 1, the network connected proximity user devices 40 combine the features and capabilities of the network connected user device 70 and the proximity credit transfer device 20S. As a result, fewer wireless communications between devices are required.

With regards to both propagation and redemption, the network connected proximity user devices 40 use their one or more applications 12A and typically disable the dedicated wireless transceivers 286m of their add-on modules 110. The devices 40 instead use the wireless transmission capabilities of its underlying network connected user device 70 for communications with the network cloud 50 and the various components required to execute the propagation and redemption operations.

While this invention has been particularly shown and described with references to preferred embodiments thereof, it will be understood by those skilled in the art that various changes in form and details may be made therein without departing from the scope of the invention encompassed by the appended claims.

What is claimed is:

1. A credit management system, the system comprising:
proximity credit transfer devices that each have a body and that each include:
device data and credits stored within the device data;
a user interface that configures the proximity credit transfer devices as sender devices or receiver devices and selects at least some of the stored credits (“selected credit amount”) at the sender devices;
wherein in response to a physical impact detected at the body of a sender device, the sender device:
pairs a receiver device that is in closest proximity to the sender device; and
creates an encrypted point-to-point wireless link with the paired receiver device and sends the selected credit amount over the link to the paired receiver device.

2. The system of claim 1, wherein each of the proximity credit transfer devices include:
a central processing unit (MPU);
one or more impact sensing devices that detect physical impacts at the bodies of the proximity credit transfer devices and send signals indicating the impacts to the MPU; and
a wireless transceiver that the MPU enables upon receiving the signals indicating the impacts.

3. The system of claim 1, wherein the sender device is a network connected user device that has been adapted to operate as a proximity credit transfer device.

4. The system of claim 1, wherein the paired receiver device is a network connected user device that has been adapted to operate as a proximity credit transfer device.

5. The system of claim 1, wherein each of the receiver devices listen for a wireless pairing request message sent from the sender device in response to a physical impact detected at the body of each receiver device, and then send a wireless pairing response message to the sender device.

6. The system of claim 5, wherein the sender device pairs the receiver device in closest proximity to the sender device by selecting the wireless pairing response message with the highest received signal strength indicator (RSSI) value, and using a proximity device identifier (ID) of the selected wireless pairing response message to identify the paired receiver device.

7. The system of claim 1, wherein a physical impact detected at the body of a specific receiver device and the physical impact detected at the body of the sender device are the result of the body of the sender device physically impacting the body of the specific receiver device.

8. The system of claim 1, wherein after the sender device detects the physical impact upon the body of the sender device, the receiver devices must be located within a proximity distance of one meter or less from the sender device and remain so for an event window time period maintained at the sender device in order for the sending of the selected amount of credits to be successful.

9. The system of claim 1, wherein the sender device sends the selected credit amount over the link to the paired receiver device with a security code, and the paired receiver device accepts the selected credit amount upon determining that a security code of the receiver device matches the sent security code.

10. The system of claim 1, wherein in response to the sending of the selected credit amount:
the paired receiver device increases its credits by the selected credit amount and stores the credits to its device data, and sends a transaction receipt message to the sender device; and
in response to receiving the transaction receipt message, the sender device decreases its stored credits by the selected credit amount and stores the credits to its device data.

11. The system of claim 1, wherein the system further comprises:
a web service API;
applications executing on network connected user devices that are each associated with a specific user, are in communication with the web service API, and are each registered with a particular proximity credit transfer device;
wherein the applications for each of the users:
enable the users to purchase credits at the web service API, and propagate the purchased credits to the registered proximity credit transfer devices; and
extract at least some of the stored credits from the registered proximity credit transfer devices, and redeem the at least some of the extracted stored credits at the web service API.

12. A credit transfer method, the method comprising:
configuring a proximity credit transfer device as a sender device and other proximity credit transfer devices as receiver devices; and
the sender device detecting a physical impact at a body of the sender device, and in response to detecting the impact, the sender device:
accessing credits stored in device data of the sender device and selecting an amount of the stored credits (“selected credit amount”);
pairing a receiver device in closest proximity to the sender device; and
creating an encrypted point-to-point link with the paired receiver device and sending the selected credit amount over the link to the paired receiver device.

13. The method of claim 12, further comprising the sender device being a network connected user device and adapting the sender device to operate as a proximity credit transfer device.

14. The method of claim 12, further comprising the paired receiver device being a network connected user device and adapting the paired receiver device to operate as a proximity credit transfer device.

15. The method of claim 12, further comprising each of the receiver devices listening for a wireless pairing request message sent from the sender device, in response to detecting an impact at the body of each of the receiver devices, and then sending a pairing response message to the sender device.

16. The method of claim 15, wherein pairing a receiver device in closest proximity to the sender device comprises selecting the pairing response message with the highest RSSI value, and using the proximity device ID of the selected pairing response message for identifying the paired receiver device.

17. The method of claim 12, further comprising a specific receiver device detecting a physical impact at a body of the specific receiver device, the physical impact at the body of the specific receiver device being the result of the body of the sender device physically impacting the body of the specific receiver device.

18. The method of claim 12, further comprising the sender device sending the selected credit amount over the link to the paired receiver device with a security code, and the paired receiver device accepting the selected credit amount upon determining that a security code of the receiver device matches the sent security code.

19. The method of claim 12, further comprising the sender device:
receiving a transaction receipt message from the paired receiver device over the link, in response to the paired receiver device accepting the selected credit amount sent by the sender device; and
reducing its stored credits by the selected credit amount.

20. The method of claim 11, further comprising:
registering applications executing on network connected user devices to communicate with the proximity credit transfer devices, and enabling users associated with each of the applications to purchase credits via a web service API;
each of the applications propagating the purchased credits to the registered proximity credit transfer devices; and
the applications extracting at least some of the stored credits from the registered proximity credit transfer devices, and redeeming the at least some of the extracted stored credits at the web service API.
